(19) United States
(12) Patent Application Publication
(10) Pub. No.: US 2010/0097596 A1
(43) Pub. Date: Apr. 22, 2010

(54) SCANNING EXPOSURE METHOD

(75) Inventors: Chiang-Lin Shih, Taoyuan County (TW); Chun-Yen Huang, Taoyuan County (TW)

Correspondence Address: QUINTERO LAW OFFICE, PC, 615 Hampton Dr, Suite A202, Venice, CA, 90291, US

(73) Assignee: NANYA TECHNOLOGY CORPORATION, Taoyuan (TW)

(21) Appl. No.: 12/356,849

(22) Filed: Jan. 21, 2009

(30) Foreign Application Priority Data
Oct. 17, 2008 (TW) TW97139881

(51) Int. Cl. G03B 27/32

(52) U.S. Cl. 355/77

(57) ABSTRACT

A scanning exposure method is provided. A mask and a substrate are oppositely moved along a direction. The mask and the substrate are moved in at least two different uniform relative velocities during a one shot exposure, thus producing an exposed shot area of an expected size on the substrate.

### CROSS REFERENCE TO RELATED APPLICATIONS

This Application claims priority of Taiwan Patent Application No. 97139881, filed on Oct. 17, 2008, the entirety of which is incorporated by reference herein.

### BACKGROUND OF THE INVENTION

1. Field of the Invention

The present invention relates to a lithography method, and in particular relates to a scanning exposure method.

2. Description of the Related Art

Continuing advances in semiconductor manufacturing processes have resulted in semiconductor devices with precision features and/or higher degrees of integration manufactured by using higher level process control technologies. Therefore, for the lithography process, the overlay quality between semiconductor layers is important due to the scaling down of critical dimensions (CD) of the semiconductor layers.

For semiconductor wafer manufacturing, to obtain appropriate exposure parameters of an exposure tool to manufacture products, a test wafer is usually used first to test the exposure tool before production ramp-up. The exposed test wafer is tested by an overlay measurement tool to obtain data such as the overlay shift value between a current photoresist and a pre-layer. The measured data can be used to decide on the exposure parameters of the exposure tool for exposing subsequent wafer lots.

However, due to a real structural difference between the pre-layer of the test wafer and multi pre-layers of the product wafer, there are slight differences in the overlay shift relationship of the pre-layer and current layer of the test wafer and the product wafer, even if the test wafer and the product wafer are exposed by using the same exposure parameters. Therefore, the exposure parameters can not effectively be determined by merely only using the measured data of the test wafer. In addition, running test wafers before production ramp-up to obtain the exposure parameters result in higher costs due to the requirement of using acid solvents to rework the exposed test wafer. Moreover, increased running of test wafers decreases lifespan of the exposure tool. Therefore, production yield is decreased and manufacturing costs are increased.

### BRIEF SUMMARY OF INVENTION

A detailed description is given in the following embodiments with reference to the accompanying drawings.

The invention provides a scanning exposure method. A mask and a substrate are moved oppositely along a direction in at least two different uniform relative velocities during a one shot exposure, thus producing an exposed shot area of an expected size on the substrate.

The invention also provides a scanning exposure method. A mask and a substrate are moved oppositely along a direction to transfer a pattern of the mask onto a shot area of the substrate, wherein the exposed shot area has an expected size. A uniform relative velocity (Vi) of the mask and substrate is determined according to a historical information of the exposure tool and a measured data of the previously exposed substrate. Said historical information of the exposure tool comprises a uniform relative velocity (Vo) of the mask and substrate during a previous exposure duration of at least on substrate, and said measured data of the previously exposed substrate comprises the measure data of an exposed shot area on the substrate.

### BRIEF DESCRIPTION OF DRAWINGS

The present invention can be more fully understood by reading the subsequent detailed description and examples with references made to the accompanying drawings, wherein:

FIG. 1 shows an exposure tool according to an embodiment of the present invention.

FIG. 2 shows a relative velocity of a mask and wafer that is varied during a one shot exposure duration of a wafer by a scanning exposure tool.

FIG. 3 shows a wafer with a shot area thereon according to an embodiment of the present invention.

FIG. 4A shows a wafer with a shot area thereon according to an embodiment of the present invention.

FIG. 4B shows a relative velocity of a mask and wafer that is varied during moving duration in one shot exposure to the wafer by a scanning exposure tool.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

A scanning exposure method of the present invention is provided. Preferred exposure parameters of an exposure tool can be determined by using exposure tool historical information of a previously processed substrate, and measured data of the exposed substrate. The obtained exposure parameters can be used for offsetting (or compensating) fabrication process degree shifts or variations of the exposure tool. Therefore, a subsequent wafer exposure by the exposure tool can have an exposed shot area of an expected size thereon. In addition, the overlay quality between a current photoresist layer and a pre-layer is improved. The substrate may be a wafer, a display substrate, an optical element substrate, a PCB, or other materials which can be exposed.

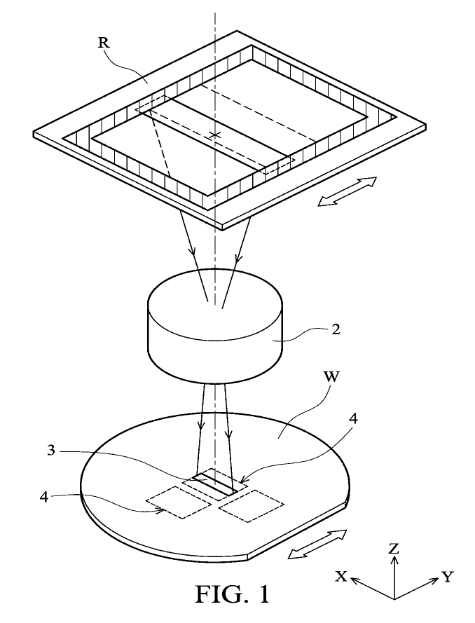

The scanning exposure method, with, for example, a semiconductor wafer, is used to describe the disclosure as follows. Referring to FIG. 1, the exposure tool comprises a mask stage carrying a patterned mask R, a substrate stage carrying a wafer W coated with a photoresist, and a projecting optical system 2 arranged at a vertical direction to the mask stage and the substrate stage. In the scanning process, a part of the pattern of the mask R is projected continuously onto the wafer W through a narrow chinked or rectangular shaped shot area (effective projected area) 3, extending in X direction formed through the projecting optical system 2. As the mask R and the wafer W are moved continuously and oppositely along a one space direction (Y direction) relative to a viewing from the projecting optical system 2, the pattern of a specific area of the mask R is transferred onto a specific shot area 4 of the wafer W.

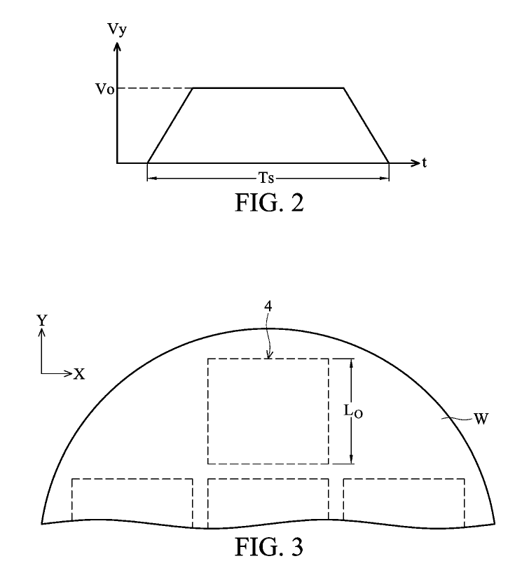

FIG.2 shows a relative velocity (Vy) of the mask R and wafer W varied during moving duration (Ts) during one shot exposure to the wafer W by the scanning exposure tool. The uniform relative velocity of the mask R and wafer W is Vo. After the wafer W is exposed, a measurement data of the wafer W is obtained by using a measuring tool. The measurement data of the exposed wafer comprises an overlay shift between a current photoresist layer and a pre-layer measured by using an overlay measuring tool. One factor of the overlay shift is that, after the current photoresist layer is exposed, a size (Lo) of the moving direction of the mask R or substrate W (Y direction) of the shot area on the wafer, especially shot area 4 near an edge of the wafer W, is bigger or smaller than the expected size (Li) as shown in FIG. 3.

In one embodiment, the uniform relative velocity (Vi) value of the mask and substrate in the exposure tool is determined by using the equation: Vo/Lo=Vi/Li before subsequent wafer exposure. For example, after a wafer is exposed with the uniform relative velocity (Vi) by the scanning exposure tool, at least one shift value of measured reference points designated on the exposed shot area on the wafer can be obtained by using the measurement data such as the overlay measurement data of the measured reference points. The significant size (Lo) of the exposed shot area can be obtained by using an average value or other preferred reference values calculated with the statistic of shift values of the measurement reference points. The size (Lo) of the shot area of the wafer may be an average value or other preferred reference size values calculated with the statistics of the sizes of shot areas of wafers exposed by the exposure tool in the uniform relative velocity Vo during previous runs. Subsequently, as a wafer is exposed by the exposure tool in the uniform relative velocity (Vi) of the mask and wafer obtained by the above equation, the wafer has a shot area of an expected size (Li) of the moving direction of the mask R or substrate W (Y direction).

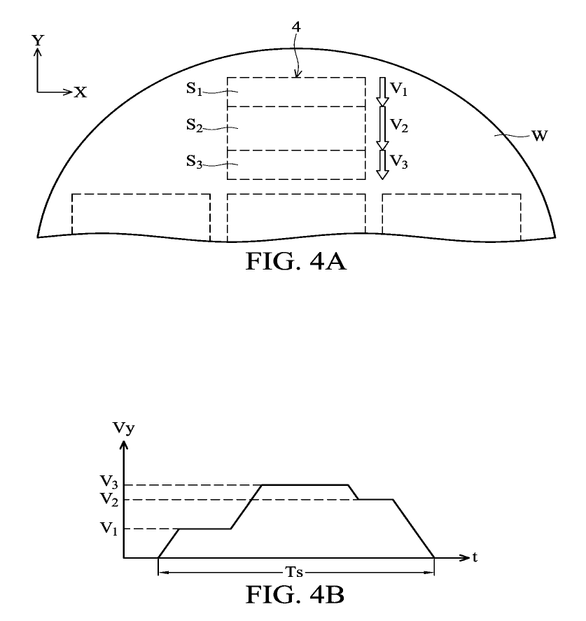

In other embodiments, after the wafer is exposed in the uniform relative velocity Vo by the scanning exposure tool, an exposed shot area on the wafer can be appropriately divided along Y direction into several reference areas by using measurement data of measured reference points designated on the exposed shot area. For example, in FIG. 4A, the shot area is divided into three reference areas S1, S2, and S3. Respectively, each of the reference area has a size (Lo) of Y direction. Thus, during a one shot, the mask and wafer has uniform relative velocities, each of which was determined by using the equation: Vo/Lo=Vi/Li, corresponding to the corresponding reference areas, respectively. Therefore, as the reference areas have different sizes, the mask and wafer has at least two different uniform relative velocities determined by using the equation: Vo/Lo=Vi/Li during the one shot. Referring to FIGS. 4A and 4B, for example, when a wafer is scanned and exposed by the exposure tool in one shot, the mask and wafer has different uniform relative velocities V1, V2, and V3 corresponding to the reference area S1, S2, and S3 during moving duration Ts. Therefore, the exposed shot area 4 of the wafer W has an expected size during exposure duration (Y direction) of the mask and wafer W.

The embodiments of the invention have several advantages, for example, the stable process performance (overlay measurement data) of the exposure tool for forming a current layer can be maintained. When the overlay measurement data of a previously processed wafer is shifted from the expected value, by using the exposure method of the invention, the shift degree for following processed wafer trends can be reduced. Therefore, the overlay shift degree between the current layer and the pre-layer can be improved, and failed wafer yield is reduced.

Not limited to the aforementioned method of using the relative moving velocity of the mask and wafer, in one embodiment, a preferred mask or wafer moving velocity can be determined by using the relationship between a mask or wafer moving velocity and a size of the shot area of the wafer.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A scanning exposure method, comprising:
moving a mask and a substrate oppositely along a direction, wherein the mask and substrate are moved in at least two different uniform relative velocities during a one shot exposure, thus producing an exposed shot area of an expected size on the substrate.

2. The scanning exposure method as claimed in claim 1, wherein each of the uniform relative velocities (Vi) is determined by a method comprising:
providing historical information of the exposure tool, comprising a uniform relative velocity (Vo) of the mask and substrate during a previous exposure duration of at least one substrate;
providing measured data of the previously exposed substrate, comprising the measured data of an exposed shot area on the substrate; and
determining the uniform relative velocity (Vi) of the mask and substrate according to the historical information of the exposure tool and the measured data of the previously exposed substrate.

3. The scanning exposure method as claimed in claim 2, wherein the expected size of the shot area of the substrate includes a length (Li) of the shot area of the moving direction.

4. The scanning exposure method as claimed in claim 3, wherein the measured data of the shot area of the previously exposed substrate comprises a length (Lo) of the shot area of the moving direction.

5. The scanning exposure method as claimed in claim 3, wherein the measured data of the shot area of the previously exposed substrate comprises a length (Lo) of the shot area of the moving direction obtained by an overlay measurement.

6. The scanning exposure method as claimed in claim 4, wherein the uniform relative velocity (Vi) of the mask and substrate is determined by using an equation: Vo/Lo=Vi/Li.

7. A scanning exposure method, comprising:
moving a mask and a substrate oppositely along a direction to transfer a pattern of the mask onto a shot area of the substrate, wherein the exposed shot area has an expected size and a uniform relative velocity (Vi) of the mask and the substrate is determined by a method comprising:
determining the uniform relative velocity (Vi) of the mask and substrate according to a historical information of the exposure tool and a measured data of the previously exposed substrate, wherein the historical information of the exposure tool comprises a uniform relative velocity (Vo) of the mask and substrate during a previous exposure duration of at least on substrate and the measured data of the previously exposed substrate comprises the measure data of an exposed shot area on the substrate.

8. The scanning exposure method as claimed in claim 7, wherein the expected size of the shot area of the substrate includes a length (Li) of the shot area of the moving direction, the measured data of the shot area of the previously exposed substrate comprises a length (Lo) of the shot area of the moving direction, and the uniform relative velocity (Vi) of the mask and substrate is determined by using an equation: Vo/Lo=Vi/Li.

9. The scanning exposure method as claimed in claim 7, wherein the measured data of the shot area of the previously exposed substrate comprises a length (Lo) of the shot area of the moving direction.
